(19) United States
(12) Patent Application Publication
(10) Pub. No.: US 2024/0404341 A1
(43) Pub. Date: Dec. 5, 2024

(54) USE OF A PAYMENT CARD TO UNLOCK A LOCK

(71) Applicant: Capital One Services, LLC, McLean, VA (US)

(72) Inventors: Tyler MAIMAN, Melville, NY (US); Negar KALBASI, Washington, DC (US); Salik SHAH, Washington, DC (US); Matthew HORTON, Tulsa, OK (US); Abdelkader M’Hamed BENKREIRA, Washington, DC (US); Phoebe ATKINS, Rockville, VA (US); Imren JOHAR, Clifton, VA (US)

(73) Assignee: Capital One Services, LLC, McLean, VA (US)

(21) Appl. No.: 18/800,749

(22) Filed: Aug. 12, 2024

Related U.S. Application Data
(63) Continuation of application No. 17/477,244, filed on Sep. 16, 2021, now Pat. No. 12,062,258.

(51) Int. Cl. G07C 9/22; G06Q 20/32; G06Q 20/34; G07C 9/00

(52) U.S. Cl. CPC G07C 9/22; G06Q 20/3223; G06Q 20/3278; G06Q 20/352; G07C 9/00309; G07C 9/00904; G06Q 2220/00; G07C 2009/00769

(57) ABSTRACT

Exemplary embodiments may provide keys for unlocking access to a location, like a user room, a secure location, a door at an employee location, a trunk, a closet or other locked location or item, on a payment card. Examples of a payment card include but are not limited to a credit card, a debit card, a smart card, an employee identification card, etc. A secure token that acts as digital key may be uploaded to the payment card. The payment card may then be put in close proximity of a wireless reader at the lock. The wireless reader obtains the secure token and extracts the contents. If the contents are proper, the lock is unlocked. Otherwise, the lock remains locked.

### RELATED APPLICATIONS

This application is a continuation of U.S. patent application Ser. No. 17/477,244, filed on Sep. 16, 2021, titled “USE OF A PAYMENT CARD TO UNLOCK A LOCK”.

The contents of the aforementioned application are incorporated herein by reference in their entirety.

### BACKGROUND

Lodging establishments, such as hotels, provide keys to their guests to access their rooms. The keys typically are either plastic key cards with magnetic strips or plastic key cards with Radio Frequency Identification (RFID) tags. With a plastic key card having a magnetic strip, a hotel clerk encodes information regarding the guest onto the magnetic strip of the card at the time of check in before handing the plastic key card to the guest. For instance, an identifier of the guest, a valid date/time, an expiration date/time and a room number may be encoded onto the magnetic strip. When the guest wishes to use the plastic key card, the guest runs an edge of the plastic key card having the magnetic strip through a magnetic card reader integrated into the door of the guest's room. The magnetic card reader reads information off of the magnetic strip and the information is analyzed by the lock. If the information is the correct information for unlocking the door, the lock to the door is unlocked so that the guest may access the room. If the information is not proper for unlocking the door, access is denied, and the door remains locked.

The plastic key card with an RFID chip operates somewhat differently. The hotel clerk encodes guest information in the RFID chip of the plastic key card at the time of check in before giving the guest the plastic key card. When the guest wishes to use the plastic key card, the guest places the plastic key card up against an RFID reader that is integrated into the door of a guest room. The RFID reader reads information wirelessly from the RFID chip in the plastic key card. If the information is the correct information for unlocking the door, the lock to the door is unlocked so that the guest may access the room. If the information is not proper to unlock the door, access is denied, and the door remains locked.

Such plastic key cards may also be used for other purposes. For example, employers may give employees such plastic key cards to gain access to the employer premises or to gain access to secure areas. For example, a secure laboratory in a corporation may require key card access. The plastic key cards may be used to access other locations where a lock is deemed necessary. Such plastic key card may even be used with locked items, such as trunks, safes, etc.

There are drawbacks to use of these varieties of plastic key cards. For example, these varieties of plastic key cards are not especially secure. Information on the magnetic strips or RFID tags is readily accessible to a party with a magnetic card reader or RFID reader. In addition, such plastic key cards are easily misplaced. As a result, the plastic key cards may end up in the hands of the wrong parties or the user may lose access to the locked location or item until a new card is obtained. Further, it is inconvenient for the user to have to keep track of an additional card. Lastly, it is expensive for lodging owners to have to purchase plastic key cards, especially given that many are lost or destroyed.

### SUMMARY

In accordance with an inventive aspect, a method includes receiving identity information and credentials originating from a contactless card via a wireless communication protocol. Based on the identity information and the credentials, an identity of a party is confirmed. After the identity confirmed, a code is forwarded for a payment card. The code serves as a digital key to unlock a lock.

The payment card may be a smart card or a credit card with capabilities for the wireless communication protocol. The wireless communication protocol may be a Near Field Communication (NFC) protocol. The lock may be for a hotel room. The method may further include storing a room number for the code and storing the identity of the party onto the payment card. The method may also include receiving the code from a computing device. The identity information and credentials may be received in an encrypted package.

In accordance with another inventive aspect, a method includes receiving credentials and identity information for a party at a portable computing device from a contactless card via a wireless communication protocol. The credentials and the identity information are forwarded to an authentication authority. Confirmation of the identity of the party is received. After the confirmation of the identity of the party, a code is forwarded to a payment card via the wireless communication protocol. The code serves as a digital key to unlock a lock.

The portable computing device may be a smartphone, tablet computing device, a smartwatch or a wearable device. The wireless communication protocol may be a Near Field Communication (NFC) protocol. The lock may be for a hotel room. The identity information and credentials may be received in an encrypted package. The forwarding and the receiving confirmation may be via a networked connection. The networked connection may be a wireless network connection, a cellular network connection or a wired network connection.

In accordance with an additional inventive aspect, a smart card includes a memory for storing identity information regarding a user, a key code for unlocking a lock with the smart card, computer program instructions for unlocking the lock with the key code, and computer program instructions for performing wireless payments. The smart card also includes a processor for executing the computer program instructions for unlocking the lock and the computer program instructions for performing wireless payments that are stored in the memory. The smart card further includes hardware enabling the smart card to communicate wirelessly.

The hardware may enable Near Field Communication (NFC) wireless communications.

The lock may be a lock for a door. The lock may be for a hotel room lock. The memory may further store computer program instructions for downloading the key code from a device. The device may be a smartphone.

### BRIEF DESCRIPTION OF THE DRAWINGS

FIG. 1 depicts an example of an illustrative environment for exemplary embodiments.

FIG. 2 depicts a flowchart of illustrative steps that may be performed to transfer a digital key to a payment card.

FIG. 3 depicts a flowchart of illustrative steps that may be performed in such exemplary embodiments.

FIG. 4 depicts an illustrative computing environment that may be suitable for the exemplary embodiments.

FIG. 5 depicts an illustration of the activities of the various components in performing such an interaction.

FIG. 6A depicts a front face of an illustrative contactless card suitable for exemplary embodiments.

FIG. 6B illustrates components of the contactless card of FIG. 6A.

FIG. 7 shows a diagram of components illustrating interaction between the contactless card and the computing device.

FIG. 8A shows a block diagram depicting how the cryptographic hash functions may be used in exemplary embodiments.

FIG. 8B, shows a diagram of possible types of inputs that may be hashed in exemplary embodiments.

FIG. 9 shows a block diagram depicting an encryption of a secure package in accordance with exemplary embodiments.

FIG. 10 provides a flowchart of illustrative steps that may be performed in authenticating the identity of a guest in exemplary embodiments.

FIG. 11 depicts certain items stored as part of the authentication service in exemplary embodiments.

FIG. 12 depicts a flowchart of steps performed to authenticate the initiating party in exemplary embodiments.

FIG. 13 depicts a block diagram of payment card suitable for us in exemplary embodiments.

FIG. 14 depicts a flowchart of illustrative steps that may be performed to use the payment card for payments in exemplary embodiments.

### DETAILED DESCRIPTION

Exemplary embodiments may provide keys for unlocking access to a location or item on a user's payment card. Examples of a payment card include but are not limited to a credit card, a debit card, a smart card, an employee identification card with payment capabilities. A secure token that acts as digital key may be uploaded to the payment card of the user. For example, where the key is for a lodging room, a guest may login to a website or access an application for the lodging and check in by providing personal information and payment information. The guest may, in some instances, then access a self-service terminal that encodes the payment card with a secure token that acts as a digital key. In other instances, the user may exploit the capabilities of a mobile computing device, such as a smartphone, tablet, smartwatch or a wearable device, to download the secure token using the application or website and then transfer the secure token to the payment card. The payment card may then be put in close proximity of a wireless reader at the lock. The wireless reader obtains the secure token and extracts the contents. If the contents are correct for unlocking the lock, the lock is unlocked. Otherwise, the lock remains locked.

Suitable wireless communications protocol for use in the exemplary embodiments are the Near Field Communication (NFC) protocols or other wireless communication protocols. Thus, the mobile computing device or terminal and the payment card may be NFC capable. Where the self-service terminal is used, the terminal may transfer the secure token to the payment card via NFC. Similarly, the mobile computing device may transfer the secure token to the payment card via NFC. The payment card also may transfer the secure token via NFC to the wireless reader at lock.

The exemplary embodiments have the benefit of not requiring an additional plastic card to access a locked location or item. This eliminates the need for the user to keep track of an additional plastic card. Likewise, this has the benefit of reducing the expense for issuers of the plastic key cards in that they no longer need to purchase as many plastic key cards since many users will opt to have the keys encoded to their payment cards. The digital key on the payment card used in the exemplary embodiments is less likely to be lost by users as people tend to keep close tabs on their payment cards, whereas users often do not pay close attention to their conventional plastic key cards since they can readily get a new plastic key card. The keys used in the exemplary embodiments are secure in that each secure token that acts as a digital key is encrypted and is not accessible without having the decryption key(s) that are needed to decrypt the secure package.

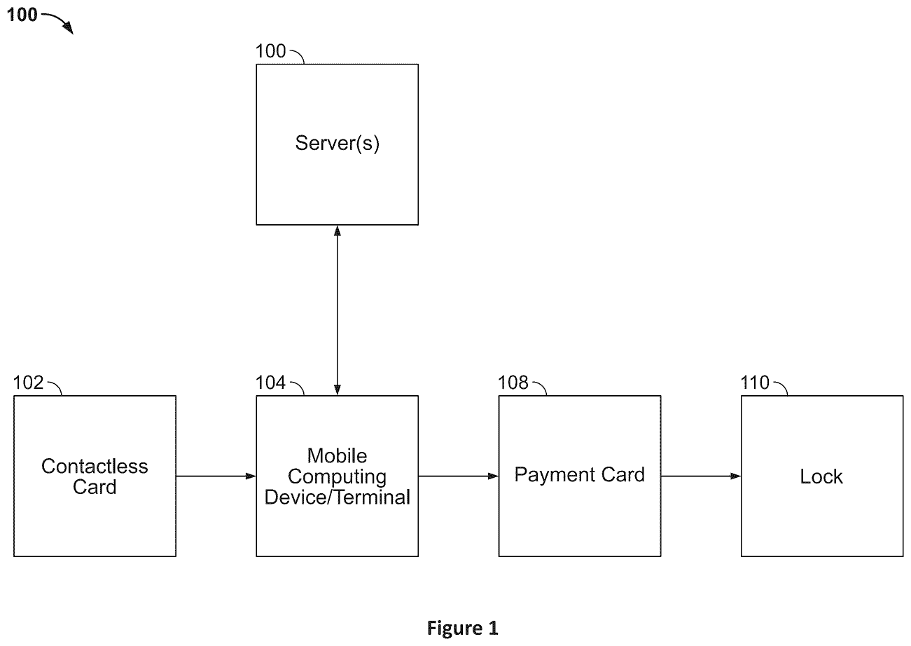

FIG. 1 depicts an example of an illustrative environment 100 for exemplary embodiments. The illustrative environment 100 includes a contactless card 102. The contactless card 102 may support the NFC protocols and communicate with other devices via the NFC protocols. For instance, the contactless card 102 may wirelessly communicate with mobile computing device or terminal 104 when in close enough proximity (e.g., within 1.5 inches) with the mobile computing device or terminal 104. Details of an illustrative contactless card 102 are provided below. The mobile computing device 104 may be, for example, a smartphone, a tablet computing device, a smartwatch, a wearable computing device or other computing device that is mobile and that possesses the requisite functionality described herein. The terminal 104 may be an NFC capable terminal or computer system interfaced with the servers(s) 106. The mobile computing device/terminal 104 may be communicate with server(s) 106 via a network connection that may be wireless, wired or a combination therein. The server(s) 106 may be web servers, may be located on the cloud or may be accessible over a local area network (LAN), a wide area network (WAN), such as the Internet or via a combination thereof.

The mobile computing device/terminal 104 may communicate with a payment card 108 of the user. For example, as mentioned above, the mobile computing device/terminal 104 may provide the secure package that acts as a digital key to the payment card 108. The payment card 108 may interact with the lock 110 as will be described below to unlock the door.

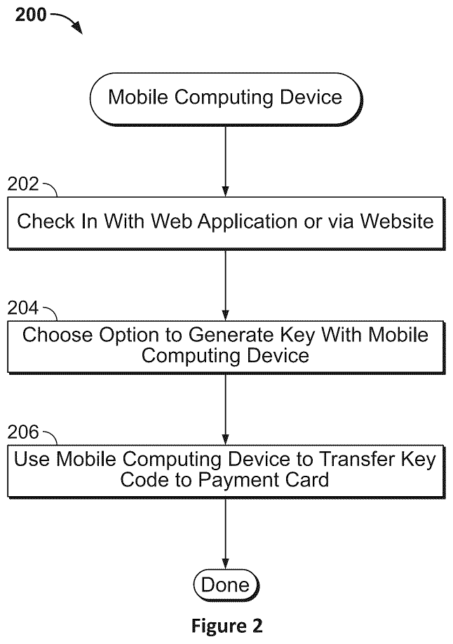

One use of the digital key on a payment card is to unlock a door of a lodging establishment, like a motel, hotel, inn or rental. There are at least two approaches that may be used in exemplary embodiments to get a digital key onto the payment card 108 for such a case where the user is to use the digital key on a payment card to unlock their lodging room or rental. In a first approach, the mobile computing device 104 transfers the digital key to the payment card 108. FIG. 2 depicts a flowchart of illustrative steps that may be performed to transfer the digital key to the payment card 108 from. Initially, the user may use the mobile computing device 104 to access an application for the lodging (such as an application for a hotel chain or rental agency) or access a website for the lodging to check in 202. The website may be running on the server(s) 106 or the application may be in communication with the server(s) 106. The user may be required to provide identity information, such as name, address and telephone number, and to provide payment information, such as credit card number, debit card number or the like, in order to check in. In some instances, the user may be prompted to tap the contactless card 102 to the mobile computing device 104 to authenticate identity, as described below. Once the guest has successfully checked in, the user may be prompted with the option to generate a digital key for storage on the payment card 108 (see 204). Where the user chooses the option to generate the digital key for storage on the payment card 108, the mobile computing device 104 transfers the secure token that acts as the digital key to the payment card 108 (see 206). As described below, the secure token may be downloaded from server(s) 106 to the mobile computing device 108 and then transferred to the payment card 108.

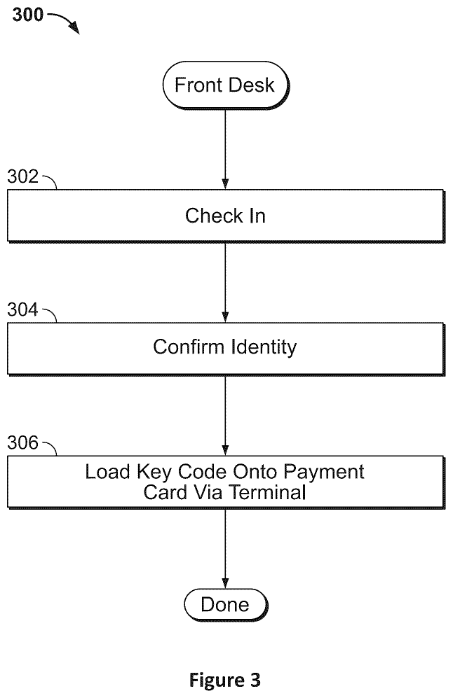

Another alternative for the use in lodging is for the key to be downloaded from a self-service terminal at a lodging front desk or kiosk. FIG. 3 depicts a flowchart 300 of illustrative steps that may be performed in such exemplary embodiments. Initially, the user checks in, such as described above, using a website or application or by providing the needed personal and payment information to a clerk or kiosk (see 302). As part of the check in, the user may be required to confirm her/his identity (see 304). This may entail showing proper identification, providing personal information via the kiosk or using the contactless card 102 to confirm identity. Once the identity of the user is confirmed, the secure token that acts as a digital key may be uploaded to the payment card 108 via a terminal 104 (see 306). The terminal 104 may be, for instance, located at the front desk of the lodging establishment. In some exemplary embodiments, the terminal 104 is NFC capable and uses NFC to transfer the secure token to the payment card 108 of the user, which is also NFC capable.

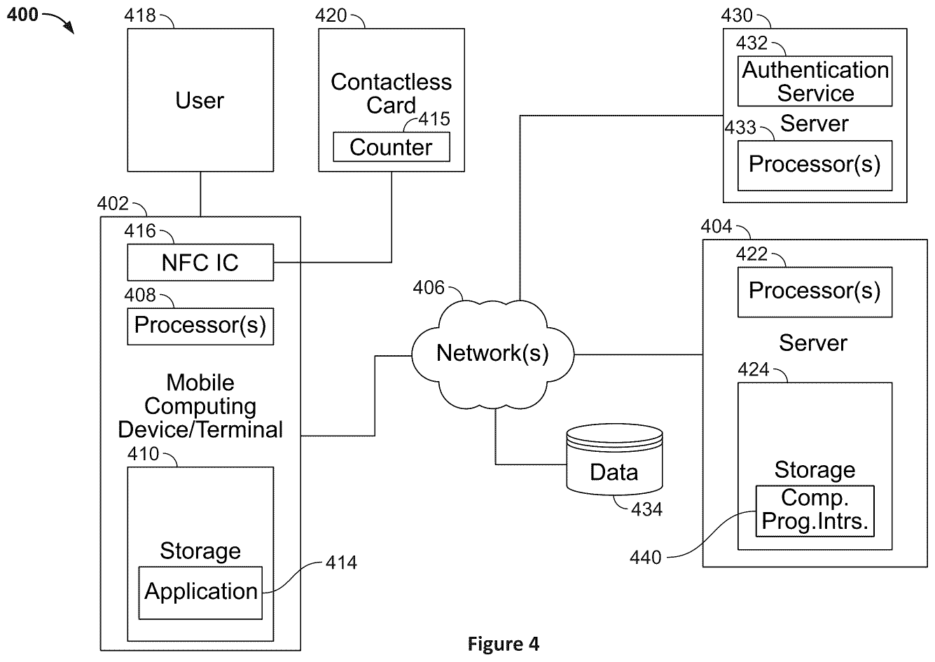

FIG. 4 depicts an illustrative computing environment 400 in greater detail than FIG. 1 that may be suitable for the exemplary embodiments. The guest 418 has access to a mobile computing device/terminal 402. The mobile computing device/terminal 402 includes a processor 408, such as a Central Processing Unit (CPU), a Graphics Processing Unit (GPU), an Application Specific Integrated Circuit (ASIC), a Field Programmable Gate Array (FPGA) or other processing unit. The processor 408 may execute instructions, such as found in computer programs, like application 414, to perform functionality described herein. The mobile computing device/terminal 402 may include storage 410 that may include Random Access Memory (RAM), Read Only Memory (ROM), solid state memory, optical disk storage, magnetic disk storage or other varieties of memory or storage for storing data and/instructions. The storage 410 may include non-transitory computer-readable storage media hold processor executable instructions. The storage 410 may store an application 414. The application 414 may provide functionality as described herein for checking in and transferring the secure token to the payment card 108. The application 414 may also enable use of the contactless card 102 to authenticate identity of the user 418. The application 414 may be a web browser in some exemplary embodiments.

The mobile computing device/terminal 402 may include an integrated circuit (IC) for providing NFC capabilities 416. The NFC IC 416 may include an NFC transceiver and a loop antenna for participating in NFC communications. A contactless card 420 may communicate with the mobile computing device/terminal 402 via NFC, such as when the contactless card is tapped against the mobile computing device/terminal 402. The contactless card 420 may include a counter 415 that is used in secure communications. A payment card 403 may wirelessly communicate with the mobile computing device/terminal via NFC or another wireless protocol.

The mobile computing device/terminal 402 may communicate with server 404 and/or server 430. In some exemplary embodiments, the mobile computing device/terminal 403 communicates directly with only server 430. These servers 404 and 430 may be connected via network(s) 406 with the mobile computing device/terminal 402. The networks(s) 406 may include wide area networks, like the Internet and/or a cellular phone network, as well as local area networks, such as corporate networks, Ethernet networks, WiFi networks, etc or intranets. Server 404 may include one or more processors 422. The processor(s) 422 may assume the many forms like those described for the processor(s) 408. The server 404 may include a storage 424, that may include the forms of storage or memory described above for storage 410 of the mobile computing device/terminal 402. The storage 424 may store computer programming instructions 440. In some exemplary embodiments, these computer programming instructions 440 are for a website that may be accessed by the user 418 to check into lodging and obtain a digital key as described above. The computer programming instructions may also be server code the interacts with the application 414 to facilitate check in and obtaining of the digital key. The server 430 may be used when authentication of the identity of the user is required and may be invoked by server 404 to provide identity authentication. The server may include processor(s) 433 that execute an authentication service 432 for authenticating a user's identity. Servers 404 and 430 may have access to data 434, such as databases and the like.

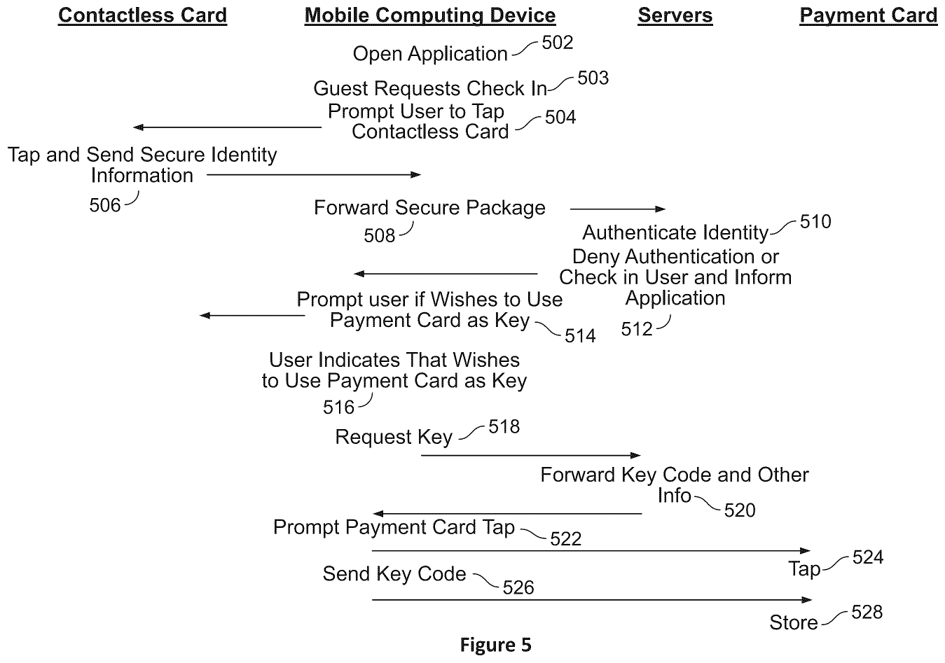

As was mentioned above, one option with using the payment card as a digital for a lodging room is for a user is to use a contactless card to prove identity and to transfer the digital key to the payment card via the mobile computing device. FIG. 5 depicts an illustration of the activities of the various components in performing such an interaction. FIG. 5 will be described with reference to the depiction of components in FIG. 4. Initially, the user 418 opens the application 414 on the mobile computing device 402 (see 502). The application may be an application for the lodging establishment or a web browser that enables access to a website for the lodging establishment. Using the application 414, the user 418 communicates with the program containing the computer program instructions 440 on the server 440 and requests check in (see 503). As part of the check in process, the application 414 prompts the user 418 to tap the contactless card 420 to the mobile computing device 402 (see 504). The contactless card 420 is tapped and sends identity information to the mobile computing device 402 in a secure package via NFC (see 506). The formation and content of the secure package from the contactless card 420 will be described in more detail below. The mobile computing device 402 sends the secure package containing the identity information to the server 404 (see 508). Server 430 may forward the secure package to the authentication service 432 on server 430. The authentication service 432 on the server 430 then authenticates the identity of the user (see 510). Once the user is authenticated, the user may be checked in, such as by server 404. In exemplary embodiments, the server 404 may ask the server 430 to perform the authentication of the identity of the user and inform the server 404 of the results. Where there is not a successful authentication, the denial may be sent to server 404 and forwarded back to the application 414 on the mobile computing device 402. Where the authentication is successful, the user is checked in and the successful check in is reported by server 404 to the application 414 on the mobile computing device 402 (see 512).

The application 414 on the mobile computing device 402 then may prompt the user to use the payment card as a key (see 514). The user may respond positively that the user wishes to use the payment card as a key (see 516). If user does not choose this option, the process halts. Otherwise, the application 414 may then request the key from server 404 (see 518). The computer program instructions 440 on the server generate the secure package that is the digital key. The key code and other information of the secure package may then be sent from the server 404 to the application 414 on the mobile computing device 402 (see 520). The application 414 prompts the user 418 to tap the payment card to the mobile computing device 402. The payment card is tapped to mobile computing device 403 (see 524). The secure package holding the digital key code may be transferred by the application 414 on the mobile computing device to the payment card via NFC as a result of the tap. In particular, the mobile computing device 402 sends the key code (see 526) and the key code is stored on the payment card (see 528).

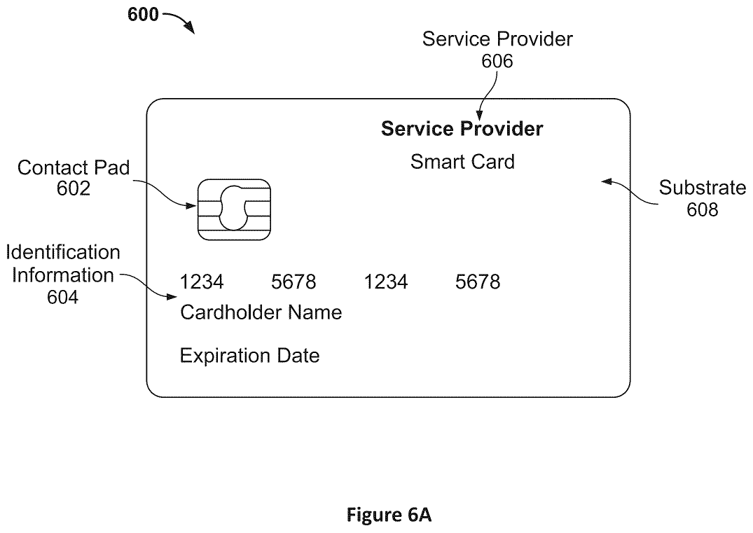

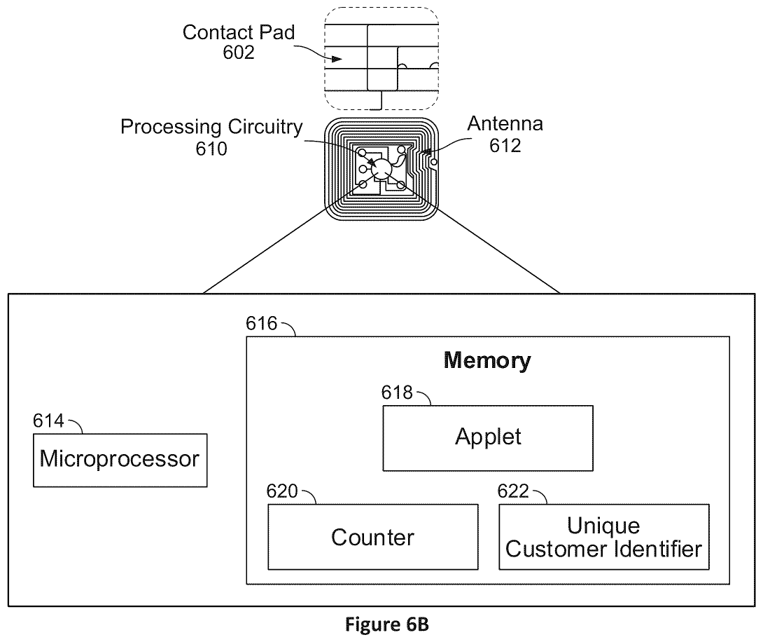

The discussion will now focus on details of the use of the contactless card. FIG. 6A illustrates an example of the front of the contactless card 600, which may be issued by a service provider 606, such as a merchant, financial institution, etc. In some exemplary embodiments, the contactless card 600 may comprise an identification card. In some instances, the card 600 may comprise a dual interface contactless payment card. The contactless card 600 may comprise a substrate 608, which may include a single layer or laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 600 may have physical characteristics compliant with the ID-1 format of the ISO/IEC 7810 standard, and the contactless card 600 may otherwise be compliant with the ISO/IEC 14443 standard. However, it is understood that the contactless card 600 according to the present disclosure may have different characteristics.

The contactless card 600 may also include identification information 604 displayed on the front and/or back of the card, and a contact pad 602. The contact pad 602 may be configured to establish contact with another communication device, such as a user device, smart phone, laptop, desktop, or tablet computer. The contactless card 600 may also include processing circuitry, antenna and other components not shown in FIG. 6A. These components may be located behind the contact pad 602 or elsewhere on the substrate 608. The contactless card 600 may also include a magnetic strip or tape, which may be located on the back of the card (not shown in FIG. 6A).

As illustrated in FIG. 6B, the contact pad 602 of FIG. 5A may include processing circuitry 610 for storing and processing information, including a microprocessor 614 and a memory 616. It is understood that the processing circuitry 610 may contain additional components, including processors, memories, error and parity/CRC checkers, data encoders, anti-collision algorithms, controllers, command decoders, security primitives and tamper proofing hardware, as necessary to perform the functions described herein.

The memory 616 may be a read-only memory, write-once read-multiple memory or read/write memory, e.g., RAM, ROM, and EEPROM, and the contactless card 600 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 616 may be configured to store one or more applets 618, one or more counters 620, and a unique customer identifier 622. The one or more applets 618 may comprise one or more software applications configured to execute on one or more contactless cards, such as Java Card applet. However, it is understood that applets 618 are not limited to Java Card applets, and instead may be any software application operable on contactless cards or other devices having limited memory. The one or more counters 620 may comprise a numeric counter sufficient to store an integer. The customer identifier 622 may comprise a unique alphanumeric identifier assigned to a user of the contactless card 600, and the identifier may distinguish the user of the contactless card from other contactless card users. In some examples, the customer identifier 622 may identify both a customer and an account assigned to that customer and may further identify the contactless card associated with the customer's account.

In some examples, the contactless card 600 may comprise one or more antennas 612. The one or more antennas 612 may be placed within the contactless card 600 and around the processing circuitry 610 of the contact pad 602. For example, the one or more antennas 612 may be integral with the processing circuitry 610 and the one or more antennas 612 may be used with an external booster coil. As another example, the one or more antennas 612 may be external to the contact pad 602 and the processing circuitry 610.

In an embodiment, the coil of contactless card 600 may act as the secondary of an air core transformer. The terminal may communicate with the contactless card 600 by cutting power or amplitude modulation. The contactless card 600 may infer the data transmitted from the terminal using the gaps in the contactless card's power connection, which may be functionally maintained through one or more capacitors. The contactless card 600 may communicate back by switching a load on the contactless card's coil or load modulation. Load modulation may be detected in the terminal's coil through interference.

As explained above, the contactless card 600 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

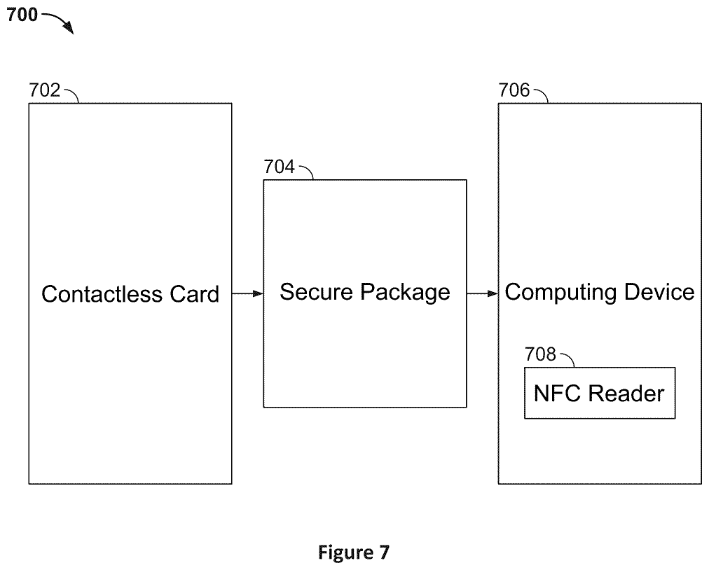

FIG. 7 shows a diagram of components illustrating interaction between the contactless card 702 and the computing device 706. The contactless card may have NFC capabilities. When the contactless card gets in proximity to an NFC reader 708 on the mobile computing device 708, identity information in a secure package 704 is transferred to the computing device.

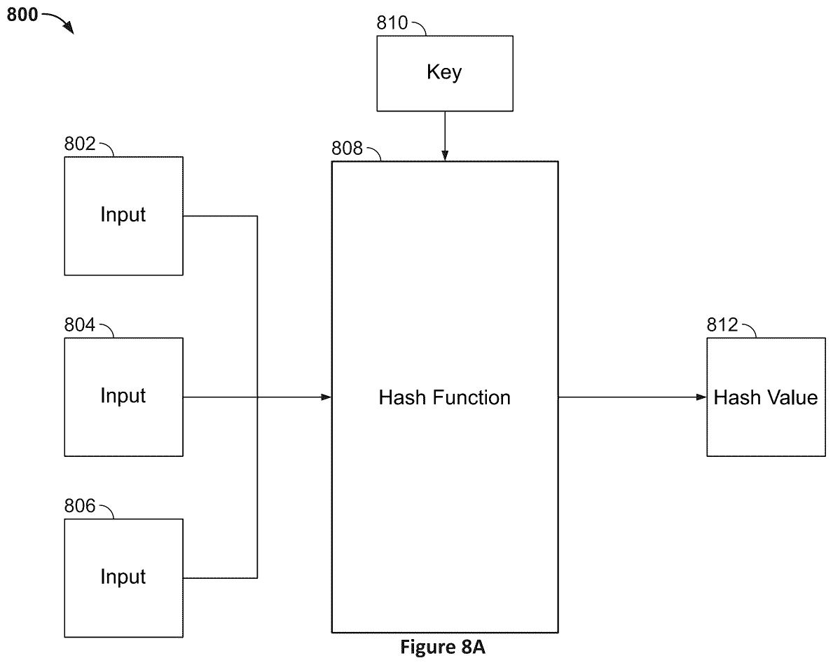

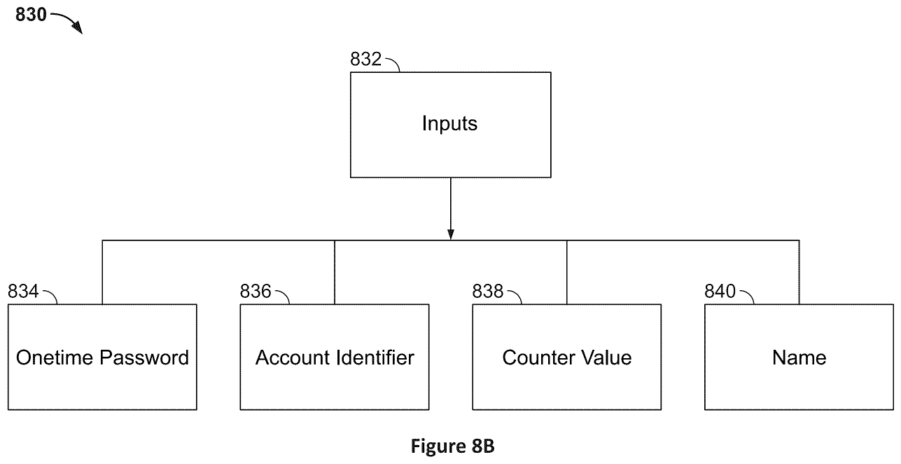

The generation of the secure package holding the identity information 704 may be generated cryptographic hash functions, such as MD5 or SHA-1. FIG. 8A shows a block diagram 800 depicting how the cryptographic hash functions may be used in exemplary embodiments. In the example shown in FIG. 8A, three inputs 802, 804 and 806 are passed through a hash function 808 together. The choice of depicting three inputs is intended to be illustrative and not limiting. Other number of inputs may be used in some instances. The hash function 808 produces an output hash value 812. Due to the nature of the hash function 808, it is computationally difficult to derive the inputs 802, 804 and 806 from the hash value 812 without knowing the key 810 used by the hash function 808. The key 810 is kept secret. The key 810 may be dynamically generated for each session and may be particular to the contactless card. Thus, the hash function 808 provides a layer of security for the content (e.g., inputs 802, 804 and 806) that is included in the secure package.

In the exemplary embodiments, the inputs 802, 804 and 806 may vary depending on the information the parties wish to exchange and the protocol for authenticating the initiating party. FIG. 8B, shows a diagram 830 of possible types of inputs 832 that may be hashed in exemplary embodiments. In these exemplary embodiments, a onetime password 834 generated by the contactless card may be included as an input. An account identifier 836 for the initiating party may be provided. This may be an account number or other identifier that uniquely identifies the account of the initiating party. The account identifier 836 may be a phone number for the initiating party. In some cases, the phone number of the initiating party may not be included in the hash value 812 but may be derived from the message sent from the mobile computing device. The inputs 832 may include a counter value 838 and/or a name 840 of the initiating party.

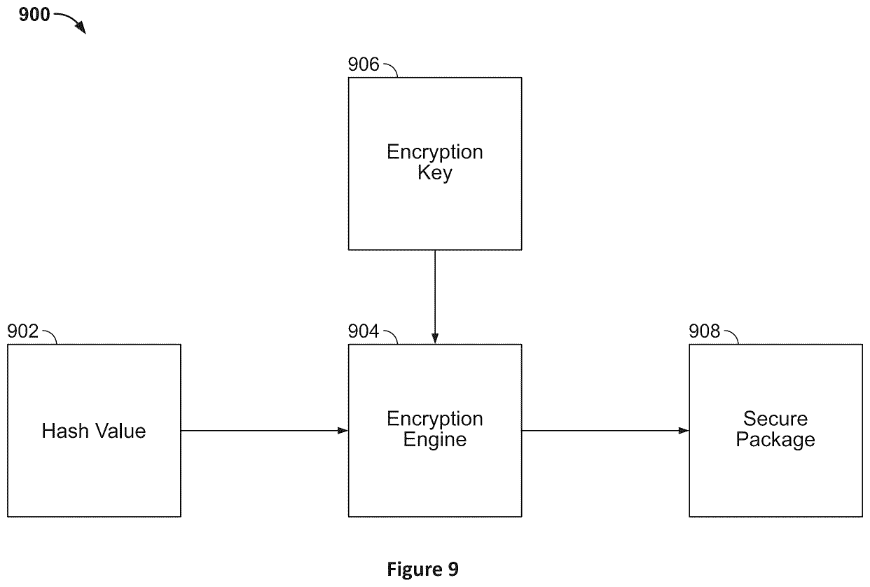

As an added layer of security, the hash value 902 may be encrypted. FIG. 9 shows a block diagram 900 depicting such encryption. The hash value 902 generated as discussed above is passed to an encryption engine 904 that encrypts the hash value using an encryption key 906. The resulting output is the secure package 908. The encryption engine 704 may use any of a number of cryptographic algorithms, such as DES, AES, RSA, DSA or the like. These may be symmetric cryptographic algorithms like DES and AES or asymmetric cryptographic algorithms like RSA and DSA. It is presumed that the authentication service 432 possesses the appropriate key to decrypt the secure package. Although not shown in FIG. 9, other content may be encrypted in conjunction with the hash value 902.

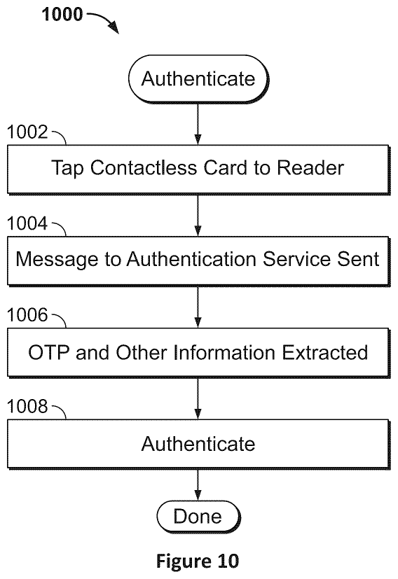

FIG. 10 provides a flowchart 1000 of illustrative steps that may be performed in authenticating the identity of the user. The user taps the contactless card 702 to the mobile computing device 706, which has an NFC reader 708 as has been discussed above (see 1002). The mobile computing device 706 sends a message containing the secure package obtained from the contactless card 702 to the authentication service 432 on server 430 (see 1004). The onetime password (OTP) and other information in the secure package are extracted (see 1006). The authentication service 432 uses the extracted information to authenticate the identity of the user (see 1008).

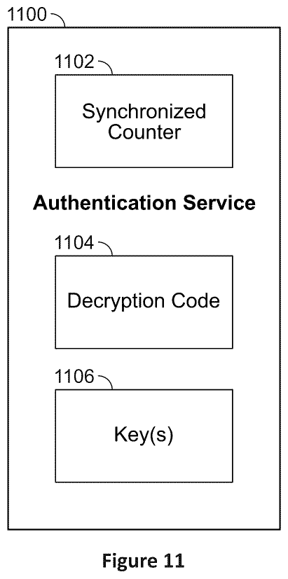

The discussion will not focus on the authentication service that receives the secure package that originated from the contactless card in more detail. FIG. 11 depicts certain items stored as part of the authentication service 1100. These items include a synchronized counter 1102 that may be used in decryption/encryption operations. The authentication service 1100 includes decryption code 1104 for performing decryption operations on the secure package. The authentication service 1100 may also store a number of decryption keys and encryption keys 1106.

Generally, the server 430 (or another computing device) and the contactless card 420 may be provisioned with the same master key (also referred to as a master symmetric key). More specifically, each contactless card 420 may be programmed with a distinct master key that has a corresponding pair in the authentication service 432. For example, when a contactless card 420 is manufactured, a unique master key may be programmed into the memory of the contactless card 420. Similarly, the unique master key may be stored in a record of a customer associated with the contactless card 420 in the account information accessible by the authentication service 432 (and/or stored in a different secure location). The master key may be kept secret from all parties other than the contactless card 432 and authentication service 432, thereby enhancing security of the system.

The master keys may be used in conjunction with the counters to enhance security using key diversification. The counters 415 and 1102 comprise values that are synchronized between the contactless card 420 and the authentication service 432. The counter value may comprise a number that changes each time data is exchanged between the contactless card 420 and the authentication service 432.

After communication has been established between mobile computing device 402 and the contactless card 420, the contactless card 420 may generate a message authentication code (MAC) cryptogram. In some examples, this may occur when the contactless card 420 is read. In particular, this may occur upon a read, such as an NFC read, of a near field data exchange (NDEF) tag, which may be created in accordance with the NFC Data Exchange Format. For example, a reader, such as the NFC reader, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, the counter value 415 maintained by the contactless card 420 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message). In some examples, the MAC cryptogram may be transmitted as an NDEF tag, and in other examples the MAC cryptogram may be included with a uniform resource indicator (e.g., as a formatted string). The contactless card 420 may then transmit the MAC cryptogram to the mobile computing device 402, which may then forward the MAC cryptogram to the authentication service 432 for verification as explained below. However, in some embodiments, the mobile computing device 402 may verify the MAC cryptogram.

More generally, when preparing to send data (e.g., to the server 430), the contactless card 420 may increment the counter 415. The contactless card 420 may then provide the master key and counter value as input to a cryptographic algorithm, which produces a diversified key as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES128; a symmetric HMAC algorithm, such as HMAC-SHA-256; and a symmetric CMAC algorithm such as AES-CMAC.

The contactless card 420 may then encrypt the data (e.g., the customer identifier and any other data) using the diversified key. The contactless card 420 may then transmit the encrypted data to the mobile computing device 402 (e.g., via an NFC connection, Bluetooth connection, etc.). The mobile computing device 402 may then transmit the encrypted data to the authentication service 432 on the server computing device 430 via the network 406. In at least one embodiment, the contactless card 420 transmits the counter value with the encrypted data. In such embodiments, the contactless card 420 may transmit an encrypted counter value, or an unencrypted counter value.

Although the counter is used as an example, other data may be used to secure communications between the contactless card 420, the mobile computing device 402, and/or the authentication service 432. For example, the counter may be replaced with a random nonce, generated each time a new diversified key is needed, the full value of a counter value sent from the contactless card 420 and the authentication service 432, a portion of a counter value sent from the contactless card 420 and the authentication service 432, a counter independently maintained by the contactless card 420 and the authentication service 432 but not sent between the two, a one-time-passcode exchanged between the contactless card 420 and the authentication service 432, and a cryptographic hash of data. In some examples, one or more portions of the diversified key may be used by the parties to create multiple diversified keys.

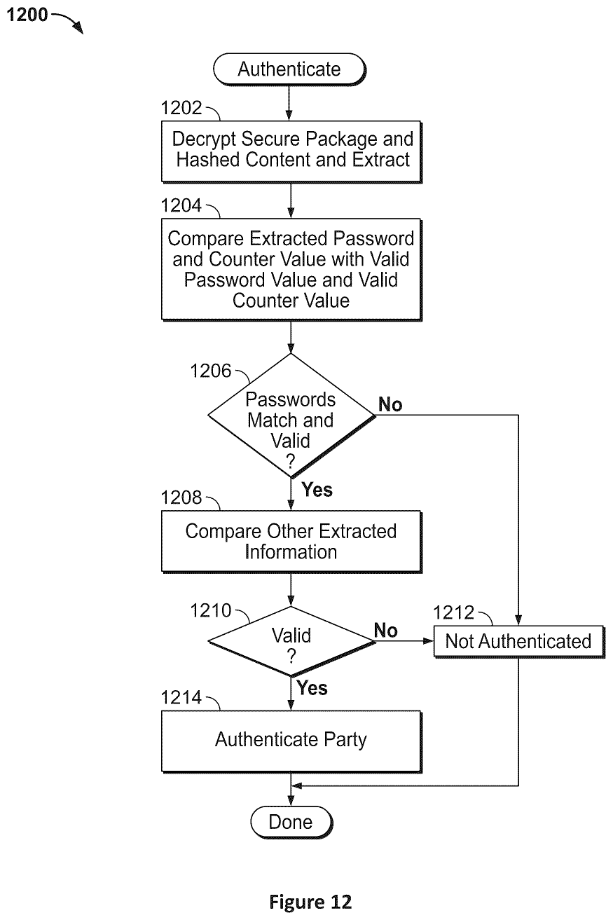

FIG. 12 depicts a flowchart 1200 of steps performed to authenticate the initiating party once the authentication message with the secure package has been received by the authentication service 432 as the recipient party. Initially, the authentication service 432 uses the decryption keys 1106 to decrypt the secure package. In addition, the decryption keys 1106 are used to decrypt the hash to extract the inputs that were hashed together by the hash function 808 (see 1202). The extracted password and counter value may be compared with the valid password and valid counter value (see 1204). A determination is made whether the passwords match and the counter values match or if the extracted counter value otherwise indicates that the password has not expired (see 1206). If the passwords match and the extracted password has not expired based on the extracted counter value, other extracted information may be compared (see 1208).

The other information may be other authentication factors 1002 such as the phone number of the mobile computing device 402, which may be compared to the phone number on record for the user 418. The other authentication factors may include a geolocation for the user. The geolocation may be information such as GPS information or area code and exchange prefix information that may be compared with information regarding the residence of the user. The other authentication factors also may include a shared secret that is shared between the user and the authentication service 432.

With reference to FIG. 12 again, if the other information is valid (see 1210), then the user 418 is authenticated (see 1214). If not, the user 418 is not authenticated (see 1212). Similarly, if the passwords do not match or the password has expired as indicated by the extracted counter value, the user is not authenticated (see 1212).

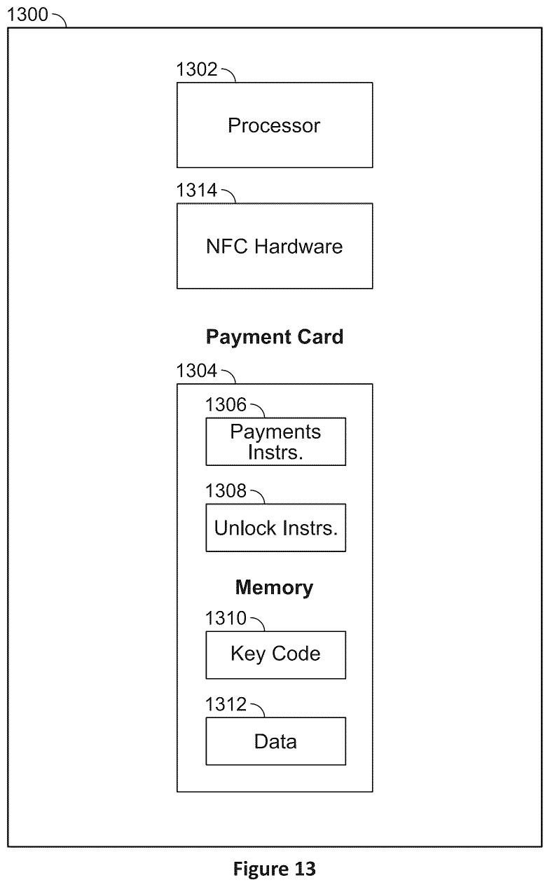

The discussion will now focus on the payment card. FIG. 13 depicts a block diagram of payment card 1300 suitable for use in exemplary embodiments. The payment card 1300 may be a credit card, a debit card or other variety of card capable of being used for payments. The payment card 1300 may be a smart card, such as a multifunction card or contact card, in some embodiments. The payment card 1300 may include a processor 1302 for executing computer programming instructions and NFC hardware 1314 for providing NFC capabilities as described above. The payment card 1300 may also include memory 1304. The memory 1304 may store instructions 1306 for performing electronic payments with the payment card. The memory 1304 may also store instructions 1308 for unlocking a lock as described above. These instructions 1306 and 1308 may be executed by the processor 1302 to perform the functionality of the payment card 1300 described above. The memory 1304 may hold the key code 1310 that is used to unlock a lock, such as a lock on a door, a lock to an area, or a lock on an item. Lastly, the memory may store data 1312.

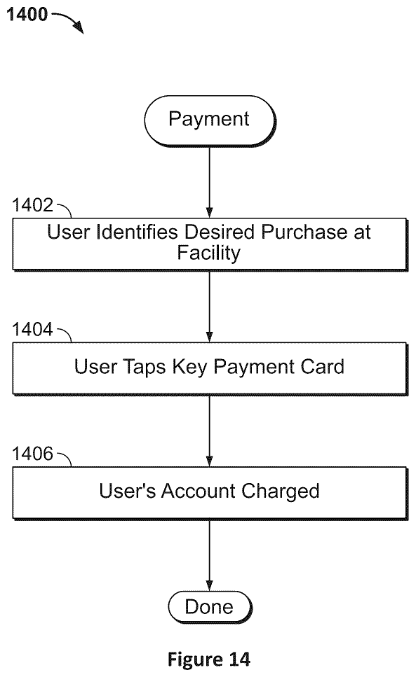

FIG. 14 depicts a flowchart 1400 of illustrative steps that may be performed to use the payment card 1300 for payments, such as at a lodging, at an employment site, at a store, etc. First, a user identifies what the user wishes to purchase (see 1402). The user then taps the payment card to a reader to realize payment (see 1404). For example, a user in a user room may pay for items from a mini bar or pay for a movie by tapping payment card to a reader positioned within the user room. The reader may be an NFC reader that may wirelessly communicate via NFC with the payment card to realize the payment. As another example, an employee may have an identification card that is NFC capable and that may be used to unlock locks to secured areas at work. The employee may tap the identification card to an NFC reader at the lunchroom checkout to pay for lunch. The user account, such as a room account, employee account or bank account, is charged for the purchase (see 1406).

While the application has focused on exemplary embodiments, it should be appreciated that various changes in form and detail may be made without departing from the scope of the claims as appended hereto.

What is claimed is:

1. A contactless card, comprising:
processing circuitry; and
memory to store:
a unique identifier to identify a user,
a key code to unlock a lock; and
a first set of instructions that when executed by the processing circuitry cause the processing circuitry to:
receive the key code,
store the key code in memory, and
in response to a request, provide the key code to a lock; and
a second set of instructions that when executed by the processing circuitry cause the processing circuitry to:
send encrypted data comprising the unique identifier to perform an authentication operation.
